(19) United States
(12) Patent Application Publication
(10) Pub. No.: US 2008/0146242 A1
(43) Pub. Date: Jun. 19, 2008

(54) Method for requesting an uplink resource allocation during a downlink data transmission

(75) Inventors: Seppo Alanara, Oulu (FI); Marko Akselin, Oulu (FI); Juha T. Kinnunen, Oulu (FI); Pasi Laitinen, Oulunsalo (FI); Asko Haapapuro, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/002,789

(22) Filed: Dec. 17, 2007

Related U.S. Application Data
(60) Provisional application No. 60/875,775, filed on Dec. 18, 2006.

(51) Int. Cl. H04Q 7/20

(52) U.S. Cl. 455/452.1

(57) ABSTRACT

A method is provided for a user equipment device to request an uplink transmission resource allocation from a base station. The method includes determining whether there is a need for the resource allocation, providing an uplink resource request to be combined with another message if the need for the resource allocation is present, combining the uplink resource request with the other message to form a combined message, and transmitting the combined message to the base station for requesting the resource allocation. The combined message may be a hybrid automatic repeat request message with an uplink resource request field. A user equipment device and a base station of a wireless communication network for performing the method are also provided.

### CROSS REFERENCE TO RELATED APPLICATIONS

This application claims priority to a provisional patent application Ser. No. 60/875,775 filed at the United States Patent and Trademark Office on Dec. 18, 2006, the contents of which is hereby incorporated by reference in its entirety.

### TECHNICAL FIELD

The present invention relates generally to data transmission in mobile communication systems. In particular, the present invention relates to uplink packet scheduling in the mobile communication systems.

### BACKGROUND ART

In mobile communication systems such as universal terrestrial radio access network (UTRAN), or the next generation, enhanced universal terrestrial radio access network (E-UTRAN), a base station (known as Node B or NB in UTRAN and eNB in E-UTRAN, referred to as Node B hereinafter) provides radio accesses to one or more mobile terminal devices (a mobile terminal device is known as a user equipment device or UE). The Node B comprises a packet scheduler for dynamically allocating uplink data packet transmission resources among all the UEs connecting to the Node B. The functions of the scheduler include dividing the available air interface capacity between the packet data users, deciding the transport channel to be used for each user's packet data transmission, and monitoring packet allocation and system load. The scheduler dynamically allocates physical layer resources for the downlink shared channel (DL-SCH) and uplink shared channel (UL-SCH) data transmissions, and sends scheduling information to the UEs through a scheduling channel. The UEs refer to the scheduling information for the timing and the data rate of the uplink transmission.

In the latest versions of UTRAN, an enhanced uplink dedicated channel (E-DCH) is provided for supporting the above scheduling mechanism and a hybrid automatic repeat request (HARQ) scheme. In E-UTRAN, a similar protocol that includes the provision of the Node B scheduling and the HARQ is also provided.

HARQ is a scheme for re-transmitting a packet to compensate for an erroneous packet when an error occurs in an initially transmitted data packet. The HARQ is used both in uplink and downlink in E-UTRAN. The HARQ functionality ensures delivery between peer entities at Layer 1 (physical layer). It uses multiple stop-and-wait processes operating in parallel. Take downlink transmission for example, for each packet received, a positive acknowledgment (ACK) is transmitted from the UE to the Node B after a cyclic redundancy check (CRC) performed by the UE indicates a successful decoding. If the CRC indicates a packet is not received correctly, the UE transmits a negative acknowledgement (NACK) in order to request a retransmission of the erroneously received packet. Uplink signalings include the one-bit HARQ positive/negative acknowledgement (HARQ-ACK/NACK), and five-bit measurement report (a channel quality indicator or CQI). At the Node B, the uplink signaling information or status report is processed in the medium access control (MAC) layer of the Node B.

The UEs are only allowed to transmit data at their allocated time intervals. If there is data to be transmitted, a UE temporarily stores the data in a buffer and transmits the data using available allocations. From time to time, the UE reports to the Node B an amount of data stored in the buffer in a buffer status report and requests an allocation of resource for transmitting the data. Sending a buffer status report itself may require an allocation of the uplink resource. In some situations, e.g. in web browsing, the downlink traffic is heavy but the uplink buffer is empty most of the time. However, now and then a request would be generated, because the user may want to send an intermittent data (for example, the user may press a key to an html link). In such a situation, it could be slow for the Node B to respond with an allocation.

Therefore, what is needed is a modified procedure that allows for a fast scheduling of uplink resources in an active downlink transmission. In that procedure, the resource allocation request can be transmitted without involving the buffer status report that may require additional resource.

Accordingly, what is also needed is a user equipment (UE) device so equipped for performing the modified procedure, and a network entity such as a Node B that facilitates the execution of the modified procedure and accepts the transmission of uplink resource request according to the procedure.

### SUMMARY OF THE INVENTION

In a first aspect of the invention, a method is provided. The method comprises determining whether there is a need for a user equipment device to request an uplink transmission resource allocation, providing an uplink resource request if the need for the resource allocation is present, combining the uplink resource request with another uplink message to form a combined message, and transmitting the combined message to a network entity for requesting the resource allocation.

In the method, the determining whether there is a need for the resource allocation may be based on one or more conditions related to reception of data from the network entity on a shared transport channel.

In the method, the other uplink message may be a hybrid automatic repeat request message. The hybrid automatic repeat request message may be a positive acknowledgement message or a negative acknowledgement message having at least one field. The combined message may be a hybrid automatic repeat request message with an uplink resource request field.

In the method above, the uplink resource request may comprise one bit of data.

In the method, the combined message may be transmitted to the network entity on a dedicated channel for hybrid automatic repeat request signaling.

In the method, the transmission of the combined message may be repeated if a transmission of the combined message is not received correctly by the network entity.

In a second aspect of the invention, an apparatus is provided. The apparatus comprises: a processor, for determining whether there is a need for an uplink transmission resource allocation, providing an uplink resource request to be combined with a hybrid automatic repeat request message if the need for the resource allocation is present, and combining the hybrid automatic repeat request message with the uplink resource request to form a combined message; and a transmitter, for transmitting the combined message to a network entity.

The apparatus may further comprise a receiver for receiving data from the network entity. The determining whether there is a need for the resource allocation may be based on one or more conditions related to reception of data from the network entity on a shared transport channel.

In the apparatus, the hybrid automatic repeat request message may be a positive acknowledgement message or a negative acknowledgement message having at least one field.

In the apparatus above, the combined message may be a hybrid automatic repeat request message with an uplink resource request field.

In the apparatus above, the uplink resource request may comprise one bit of data.

In the apparatus the transmitter may be configured to transmit the combined message to the network entity on a dedicated channel for hybrid automatic repeat request signaling.

In the apparatus, the transmission of the combined message may be repeated if a transmission of the combined message is not received correctly by the network entity.

The apparatus may be a user equipment device.

In a third aspect of the invention, a network entity is provided. The network entity comprises a receiver for receiving from a user equipment device a combined message comprising a hybrid automatic repeat request message and an uplink resource request, a scheduler for scheduling an uplink resource allocation for the device in accordance with the uplink resource request received in the combined message, and a transmitter for transmitting resource allocation information to the device.

In the network entity, the receiver may be configured to receive the combined message from the device on a dedicated channel for hybrid automatic repeat request signaling.

In the network entity, the hybrid automatic repeat request message may be a positive acknowledgement message or a negative acknowledgement message having at least one field.

In the network entity, the combined message may be a hybrid automatic repeat request message with an uplink resource request field.

The network entity may be a radio resource controller of a base station.

In a fourth aspect of the invention, a communication system is provided. The communication system comprises a network entity wirelessly in communication with a user equipment device. The device comprises: a processor for determining whether there is a need for an uplink transmission resource allocation, providing an uplink resource request to be combined with a hybrid automatic repeat request message if the need for the resource allocation is present, and combining the hybrid automatic repeat request message with the uplink resource request to form a combined message; and a transmitter for transmitting the combined message to the network entity. The network entity comprises a receiver for receiving from the device the combined message, a scheduler for scheduling an uplink resource allocation for the device in accordance with the uplink resource request received in the combined message, and a transmitter for transmitting allocation information to the device.

In a fifth aspect of the invention, a computer program product is provided. The computer program product comprises a computer readable storage medium with program codes stored thereon for use in an apparatus. The program codes comprise instructions for determining whether there is a need for the apparatus to request an uplink transmission resource allocation, instructions for providing an uplink resource request to be combined with a hybrid automatic repeat request message if the need for the resource allocation is present, instructions for combining the hybrid automatic repeat request message with the uplink resource request to form a combined message, and instructions for transmitting the combined message to a network entity.

In a sixth aspect of the invention, a further computer program product is provided. The computer program product comprises a computer readable storage medium with program codes stored thereon for use in a network entity. The program codes comprise instructions for receiving from a device a combined message comprising a hybrid automatic repeat request message and an uplink resource request, instructions for scheduling an uplink resource allocation for the device in accordance with the uplink resource request received in the combined message, and instructions for transmitting resource allocation information to the device.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a flow diagram of an uplink resource request procedure, executed without combining with HARQ signaling;

FIG. 2 is a flow diagram of an uplink resource request procedure, executed in combination with uplink HARQ signaling; and

FIG. 3 is a block diagram of a user equipment device (UE) and a base station (Node B) according to the present invention.

### DETAILED DESCRIPTION OF THE INVENTION

As mentioned in the Background of the Invention section, the uplink resource allocation is handled by a scheduler in the Node B. If a UE is in an active downlink session, for example receiving a large amount of data from the Node B (such as downloading contents from a web site), the buffer in the UE for temporarily storing untransmitted uplink data is normally empty or near empty. The scheduler in the Node B, accordingly, would not assign uplink resources to that UE. The UE may, however, request some uplink resource allocation for future use. In requesting the uplink resource for future use, an uplink buffer status report, indicating the amount of data that is buffered in the logical channel queues in the UE MAC, is provided by the UE to the scheduler. Since there is not much untransmitted data in the buffer. The scheduler might not grant the requested resource allocation immediately.

The scheduling requests are sent in the same way as uplink data transmissions. If a UE's buffer is empty, the scheduler might not schedule any resource, even for transmitting a request. Therefore, the UE might have to send the request by using a different channel, for example, the random access channel (RACH).

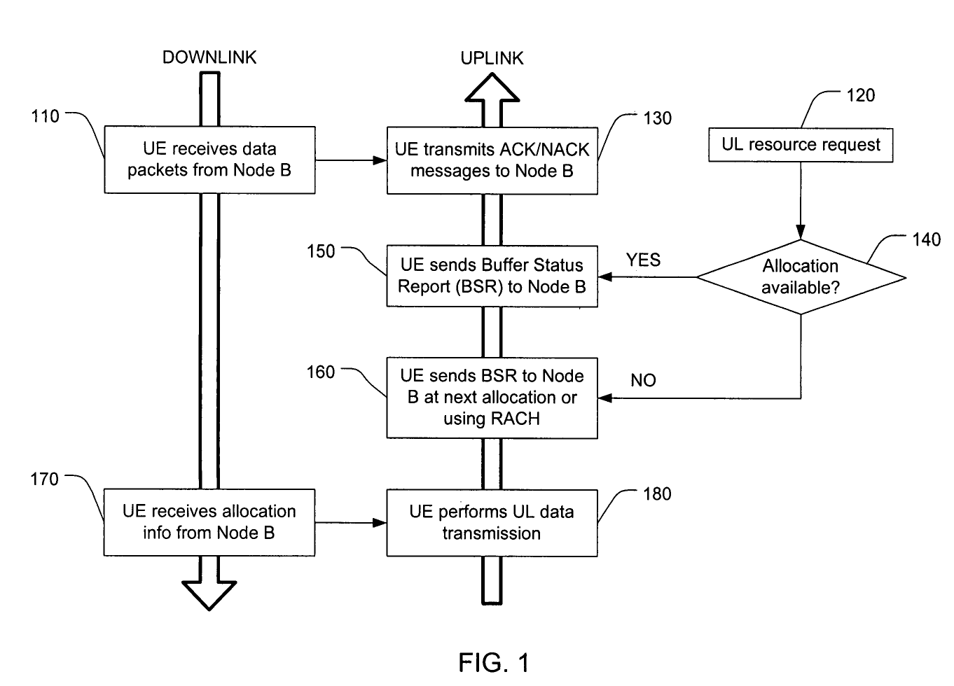

An active downlink data transmission session is illustrated in FIG. 1. The UE receives data from the Node B (110). The UE uses the HARQ scheme to send ACK (including both ACK and NACK hereinafter) messages to the Node B for each packet of data received (130). Meanwhile, if it is determined that an uplink resource allocation is needed for future use, such as for transmitting small amounts of intermittent data, the UE prepares an uplink resource allocation request (120). The UE checks if there is an allocation available for transmitting the request (140). The request includes a buffer status report, and sending the buffer status report itself needs an allocation of the uplink resource. If there is an allocation available, the UE sends the buffer status report (150), receives resource allocation information from the Node B (170), and transmits the intermittent data using the allocation (180). Most likely, however, during the active downlink transmission, the buffer is empty and there is no uplink allocation available. If there is no allocation for transmitting available currently, the UE waits for an allocation in later transmission time intervals or uses the random access channel (RACH) for transmitting such request (160). The uplink data may be transmitted after the Node B responded with an allocation (also 170 and 180).

This procedure is inefficient during such an active downlink session, because the buffer of the UE is mostly empty, and the scheduler of the Node B treats the request from the UE with a low priority. Consequently, the response from the Node B in granting an allocation is slow. Also, because the request also uses the uplink resources on a transport channel or on the RACH, it unnecessarily consumes the uplink resources.

The present invention provides a modified procedure for requesting an uplink resource allocation during an active downlink session. The uplink resource request may be sent with some another uplink signaling so it does not have to wait for the allocated time. For example, the HARQ signaling as described above can be used for carrying the uplink resource request.

If an uplink resource request is to be sent by the HARQ signaling, it can be included in a modifying HARQ massage. For example, a new field may be added to an uplink HARQ message and the new filed is used for requesting a resource allocation from the Node B scheduler.

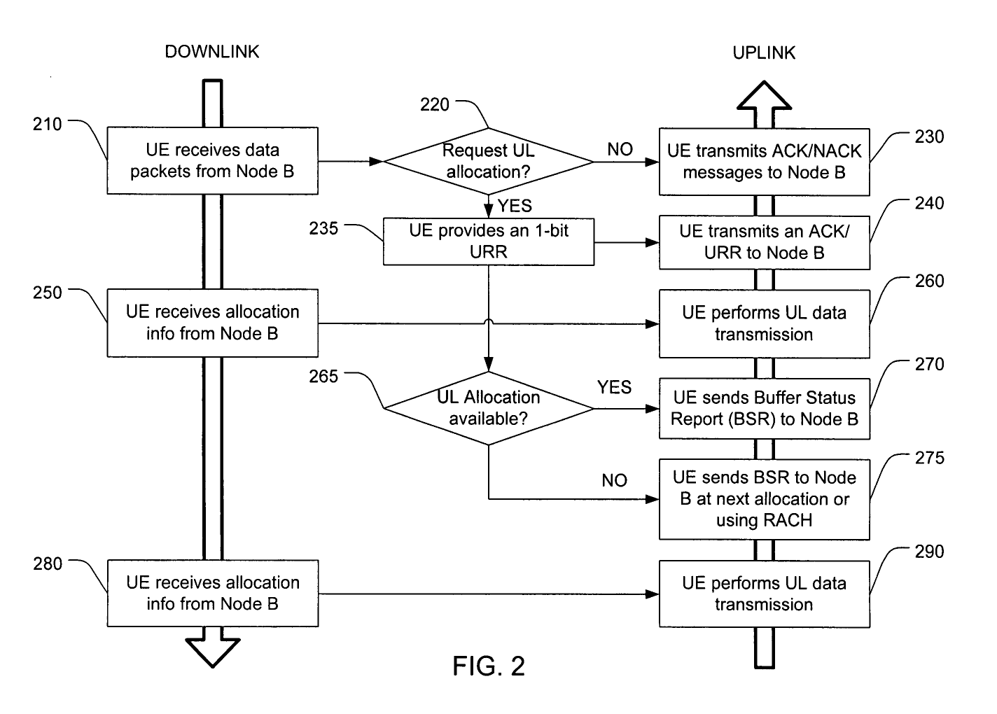

Referring now to FIG. 2, during a downlink data transmission, the UE receives data from the Node B (210). The UE checks to see if there is a need to request an uplink resource allocation for future use (220). If there is no need, the UE continues with sending HARQ ACK messages to the Node B for each packet of data received (230). If there is a need for requesting an uplink allocation, the UE provides a one-bit uplink resource request (URR) signal for adding on to an ACK message (235). This can be done by using the aforementioned new field of the ACK message. The UE then sends the ACK and the URR in one message (240) to Node B and receives allocation information from the Node B (250) for transmitting data using the allocation (260).

In case if the combined ACK message (ACK with URR attached) is not received in the Node B, it can be repeated in the next HARQ repeat.

Because in the above situation, the buffer is most likely empty, there is no need to submit a buffer status report using an allocation. In an active downlink session, the HARQ channel is always present. Linking the URR to the HARQ messaging ensures that the scheduler receives the resource request efficiently even if there is no uplink allocation available during the downlink transmission.

If the buffer is not empty, besides sending the combined ACK and URR message, which results in a fast response from the scheduler, the UE can still use the normal mechanism to request the uplink resource by sending a buffer status report. Shown in FIG. 2 as dashed components, the UE checks if there is an allocation available for transmitting the buffer status report (265). If there is allocation available, the UE sends the buffer status report (270) and receives allocation information from the Node B (280) for transmitting data using the allocation (290). If there is no uplink allocation available for transmitting the buffer status, the UE waits for an allocation in latter transmission intervals or uses the random access channel (RACH) for transmitting the buffer status report (275). The uplink data in the buffer may be transmitted after the Node B responded with allocation information (also 280 and 290).

A scenario for saving the uplink capacity by using the procedure of this invention is Web browsing. When downloading web contents, there is lots of traffic in the downlink direction but mostly just user requesting for opening a new link etc. in the uplink direction. All downlink data needs HARQ acknowledgements in form of NACK or ACK messages. Therefore, there is a constant flow of acknowledgement messages. With this invention, an ACK message is configured to contain one addition filed. Such field is reserved for a one-bit signal indicating whether or not there is a request for uplink resource allocation. Without this possibility, the RACH would have to be used in most cases for uplink requests and it may consume this shared resource significantly. So there is a considerable advantage in adding the uplink resource request to the HARQ signaling.

Summarizing the above, a method is provided for a user equipment device to request an uplink transmission resource allocation from a base station. The method comprises determining whether there is a need for the resource allocation, providing an uplink resource request if the need for the resource allocation is present, combining the uplink resource request with another uplink message, and transmitting the combined message to the base station for requesting the resource allocation.

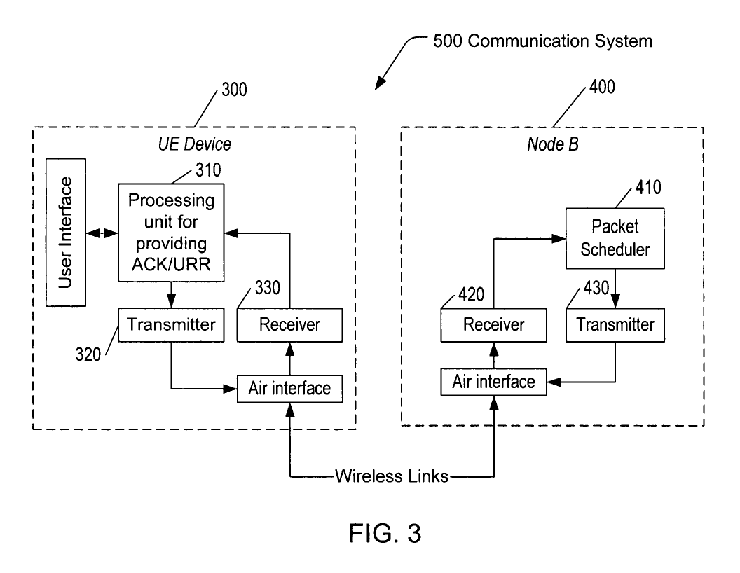

In using the invention, a wireless communication terminal device connectable to a base station of a wireless communication network is provided. As shown in FIG. 3, The device 300 comprises a processor 310, a transmitter 320 and a receiver 330. The processor 310 is configured to determine whether to request a resource allocation for transmitting data to the base station 400, provide an uplink resource request if there is a need for the resource allocation, and combine the uplink resource request with another uplink message to form a combined message. The transmitter 320 is configured to transmit the combined message to the base station 400 for requesting the resource allocation. The receiver 330 is configured to receive data including uplink resource allocation from the base station 400. The determining whether there is a need for the resource allocation may be based on one or more conditions related to reception of data from the base station 400 on a shared transport channel.

The base station 400 of a wireless communication network comprises a receiver 420 for receiving from the wireless terminal device 300 a combined message comprising a hybrid automatic repeat request message and an uplink resource request, a scheduler 410 for scheduling an uplink resource allocation for the device in accordance with the uplink resource request received in the combined message, and a transmitter 430 for transmitting information related to resource allocation to the device 300.

The wireless terminal device 300 and the base station 400 form a communication system 500 of the present invention.

Further, a computer program product, stored in a computer readable storage medium for use in a wireless terminal device is provided for performing the method of the invention. The computer program product comprises instructions for determining whether to request a resource allocation for transmitting data to a base station, instructions for providing an uplink resource request if there is a need for the resource allocation, instructions for combining the uplink resource request with another uplink message to form a combined message, and instructions for transmitting the combined message to the base station for requesting the resource allocation.

Still further, a computer program product, stored in a computer readable storage medium for use in a base station is provided for performing the method of the invention. The computer program product comprises instructions for receiving from a wireless terminal device a combined message comprising an uplink resource request, instructions for scheduling an uplink resource allocation for the device in accordance with the uplink resource request received in the combined message, and instructions for transmitting resource allocation information to the device.

The present invention has been disclosed in reference to specific examples therein. Numerous modifications and alternative arrangements may be devised by those skilled in the art without departing from the scope of the present invention. Although the invention is illustrated in connection with the uplink hybrid automatic repeat request signaling, it is understood that the invention can also be used in connection with other signaling schemes used in wireless communication networks. Also, although the invention is illustrated in connection with the UTRAN and E-UTRAN communication systems, it is understood that the invention is also applicable to other modes of operations or other wireless communication platforms.

What is claimed is:

1. A method, comprising:
determining whether there is a need for a user equipment device to request an uplink transmission resource allocation,
providing an uplink resource request if the need for the resource allocation is present,
combining the uplink resource request with another uplink message to form a combined message, and
transmitting the combined message to a network entity for requesting the resource allocation.

2. The method of claim 1, wherein the determining whether there is a need for the resource allocation is based on one or more conditions related to reception of data from the base station on a shared transport channel.

3. The method of claim 1, wherein the other uplink message is a hybrid automatic repeat request message.

4. The method of claim 3, wherein the hybrid automatic repeat request message is a positive acknowledgement message or a negative acknowledgement message having at least one field.

5. The method of claim 3, wherein the combined message is a hybrid automatic repeat request message with an uplink resource request field.

6. The method of claim 5, wherein the uplink resource request comprises one bit of data.

7. The method of claim 1, wherein the combined message is transmitted to the network entity on a dedicated channel for hybrid automatic repeat request signaling.

8. The method of claim 1, wherein the transmission of the combined message is repeated if a transmission of the combined message is not received correctly by the network entity.

9. An apparatus, comprising:
a processor, for determining whether there is a need for an uplink transmission resource allocation, providing an uplink resource request if the need for the resource allocation is present, and combining the uplink resource request with another uplink message to form a combined message, and
a transmitter for transmitting the combined message to a network entity.

10. The apparatus of claim 9, further comprising:
a receiver for receiving data from the network entity, wherein the determining whether there is a need for the resource allocation is based on one or more conditions related to reception of data from the network entity on a shared transport channel.

11. The apparatus of claim 9, wherein the other uplink message is a hybrid automatic repeat request message.

12. The apparatus of claim 11, wherein the hybrid automatic repeat request message is a positive acknowledgement message or a negative acknowledgement message having at least one field.

13. The apparatus of claim 11, wherein the combined message is a hybrid automatic repeat request message with an uplink resource request field.

14. The apparatus of claim 13, wherein the uplink resource request comprises one bit of data.

15. The apparatus of claim 10, wherein the transmitter is configured to transmit the combined message to the network entity on a dedicated channel for hybrid automatic repeat request signaling.

16. The apparatus of claim 10, wherein the transmission of the combined message is repeated if a transmission of the combined message is not received correctly by the network entity.

17. The apparatus of claim 10, wherein the apparatus is a user equipment device.

18. A network entity, comprising:
a receiver for receiving from a user equipment device a combined message comprising an uplink resource request,
a scheduler for scheduling an uplink resource allocation for the device in accordance with the uplink resource request received in the combined message, and
a transmitter for transmitting resource allocation information to the device.

19. The network entity of claim 18, wherein the receiver is configured to receive the combined message from the device on a dedicated channel for hybrid automatic repeat request signaling.

20. The network entity of claim 18, wherein the uplink resource request is combined with another uplink message and the other uplink message is a hybrid automatic repeat request message.

21. The network entity of claim 20, wherein the hybrid automatic repeat request message is a positive acknowledgement message or a negative acknowledgement message having at least one field.

22. The network entity of claim 20, wherein combined message is a hybrid automatic repeat request message with an uplink resource request field.

23. The network entity of claim 18, wherein the network entity is a radio resource controller of a base station.

24. A communication system, comprising a network entity wirelessly in communication with a user equipment device, wherein the device comprises:
a processor for determining whether there is a need for an uplink transmission resource allocation, providing an uplink resource request if the need for the resource allocation is present, and combining the uplink resource request with another uplink message to form a combined message, and
a transmitter for transmitting the combined message to the network entity, and wherein the network entity comprises:
a receiver for receiving from the device the combined message,
a scheduler for scheduling an uplink resource allocation for the device in accordance with the uplink resource request received in the combined message, and
a transmitter for transmitting allocation information to the device.

25. A computer program product, comprising a computer readable storage medium with program codes stored thereon for use in an apparatus, wherein the program codes comprise:
instructions for determining whether there is a need for the apparatus to request an uplink transmission resource allocation,
instructions for providing an uplink resource request if the need for the resource allocation is present,
instructions for combining the uplink resource request with another uplink message to form a combined message, and
instructions for transmitting the combined message to a network entity.

26. A computer program product, comprising a computer readable storage medium with program codes stored thereon for use in a network entity, wherein the program codes comprise:
instructions for receiving from a device a combined message an uplink resource request,
instructions for scheduling an uplink resource allocation for the device in accordance with the uplink resource request received in the combined message, and
instructions for transmitting resource allocation information to the device.

27. An apparatus, comprising:
means for determining whether there is a need for an uplink transmission resource allocation,
means for providing an uplink resource request if the need for the resource allocation is present,
means for combining the uplink resource request with another uplink message to form a combined message, and
means for transmitting the combined message to a network entity for requesting the resource allocation.

28. A network entity of a wireless communication network, comprising:
means for receiving from a device a combined message comprising an uplink resource request,
means for scheduling an uplink resource allocation for the device in accordance with the uplink resource request received in the combined message, and
means for transmitting resource allocation information to the device.
